(19) United States
(12) Patent Application Publication
(10) Pub. No.: US 2010/0005809 A1
(43) Pub. Date: Jan. 14, 2010

(54) GENERATING ELECTRICITY THROUGH WATER PRESSURE

(76) Inventor: Michael Anderson, Milton-Freewater, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/494,747

(22) Filed: Jun. 30, 2009

Related U.S. Application Data
(60) Provisional application No. 61/079,646, filed on Jul. 10, 2008.

(51) Int. Cl. F02C 3/22; F02C 6/02

(52) U.S. Cl. 60/780; 60/783; 60/327

(57) ABSTRACT

Methods and systems are provided for the harnessing of energy from pressure differences in bodies of water that include gases, for example hydrogen and oxygen. In one example, hydrogen and oxygen may be produced from water by electrolysis under high pressure. Pressure differences between the atmosphere and the produced gases brought about by the body of water may be then utilized to generate energy (e.g. to create a flow of fluid which may spin a turbine). In this way, energy may be produced in a clean and efficient manner, with useful byproducts that may be further processed.

### CROSS-REFERENCE TO RELATED APPLICATIONS

This application claims priority from U.S. Provisional Patent Application Ser. No. 61/079,646 of Michael Anderson, entitled “GENERATING ELECTRICITY THROUGH WATER PRESSURE,” filed Jul. 10, 2008, the disclosure of which is hereby incorporated by reference in its entirety and for all purposes.

### BACKGROUND

Useful energy (work) may be generated by harnessing conditions of energetic disequilibrium, for example from the flow of fluid. Hydroelectric dams are an example of such a method. Liquid water present at a height is coerced into moving to a lower height by the equilibrating force of gravity. Dams impede the path of flow of liquid water due to gravity and harness energy from the flow with a turbine. In this way, an equilibrating force may be utilized to generate energy.

Weight produced by large bodies of water, for example an ocean, and forces that result from such weight, for example buoyant force, also enable an energetic disequilibrium. Pressures may be observed in the deep oceans that are many times that of atmospheric pressure. Similarly, underground water reservoirs may produce large pressures at low depths. Gases produced under high pressure conditions, for example those found at the bottom of large bodies of water, may be in a state of energetic disequilibrium when compared with gases at atmospheric pressure.

### SUMMARY

The inventor herein recognizes conditions, such as the above, that enable the generation of useful energy (work). Accordingly, methods and systems are provided for the harnessing of energy from pressure differences in bodies of water that include gases, for example hydrogen and oxygen. In one example, hydrogen and oxygen may be produced from water by electrolysis under high pressure. Pressure differences between the atmosphere and the produced gases brought about by the body of water may be then utilized to generate energy (e.g. to create a flow of fluid which may spin a turbine). In this way, energy may be produced in a clean and efficient manner, with useful byproducts that may be further processed.

It should be understood that the summary above is provided to introduce in simplified form a selection of concepts that are further described in the detailed description. It is not meant to identify key or essential features of the claimed subject matter. Furthermore, the claimed subject matter is not limited to implementations that solve any disadvantages noted above or in any part of this disclosure.

### BRIEF DESCRIPTION OF THE FIGURES

FIG. 1 is a schematic diagram of an electricity generating station that utilizes deep ocean conditions.

FIG. 2 is a schematic diagram of an alternate electricity generating station that utilizes water well conditions.

### DETAILED DESCRIPTION

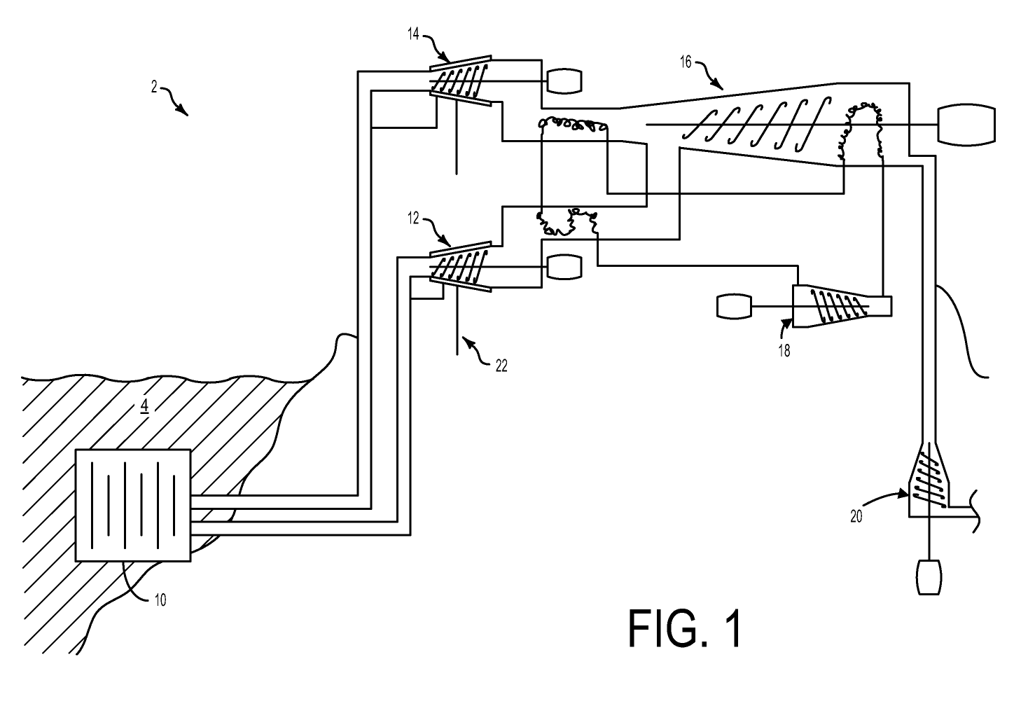

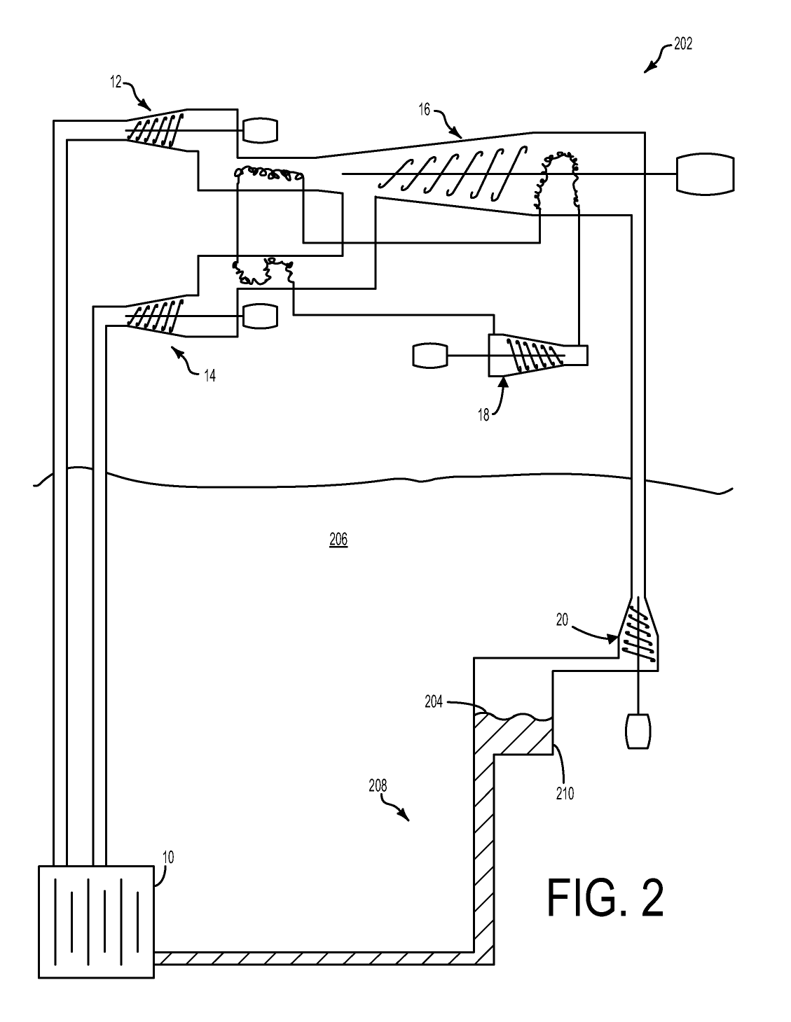

FIG. 1 is a diagram of an electricity generating station 2. The electricity generating station is an example of a system that may be used to carry out a method of harnessing energy from a high pressure gas, the pressure created by a deep body of water (for example, greater than the pressure of 50 feet of water). The electricity generating station 2 includes an electrolysis plant 10 located underwater, piping coupled to the electrolysis plant, an oxygen discharge turbine 12 coupled downstream of the piping, a hydrogen discharge turbine 14 coupled downstream of the piping, a gas turbine engine 16 coupled downstream to the oxygen discharge turbine and hydrogen discharge turbine, an inert gas turbine 18 coupled to the gas turbine engine and the hydrogen discharge turbine and oxygen discharge turbine, and a lower level turbine 20 coupled to the gas turbine engine. In further examples, the electricity generating station further includes a bleeding device 22. The electricity generating station is in fluid communication with an ocean 4. In alternate embodiments, the electricity generating plant is in fluid communication with another large body of water (as shown, for example, in FIG. 2).

The electrolysis plant 10 is a device or system used to produce gases from water, which may include hydrogen and oxygen. In one example, gases are produced from ocean water. In another example, the electrolysis plant is located at a depth of between 6000 (1.8288 kilometers) and 13,000 feet (3.9624 kilometers) below sea level. In another example, gases may be produced at 5,000 pounds per square inch (34.4737865 megapascals). In alternate examples, gases may be produced at pressures above 5000 pounds per square inch (psi). The piping may include different and isolated pipes (i.e. pipes that are not in fluid communication). In still further examples, hydrogen and oxygen gases are separated into different pipes. Separated gases may be transported to different discharge turbines in this way.

The oxygen discharge turbine 12 may receive gas from the piping and may produce electricity from the flow of oxygen gas. In some examples the oxygen discharge turbine may be located at sea level. In alternate examples, the oxygen discharge turbine may be located above sea level. The production of electricity may be done in a way similar to that of a steam turbine in a coal fired electricity plant. The hydrogen discharge turbine 14 may function in the same fashion as the oxygen discharge turbine 12, and may be located in a similar place as the oxygen discharge turbine 12. In one example, hydrogen and oxygen that have been discharged by the turbines may be at a pressure in the range of 200 psi (1.37895146 megapascals) to 400 psi (2.75790292 megapascals). In a further example hydrogen and oxygen gases that have been discharged by the turbines may be in a temperature range of negative 300° Fahrenheit (88.7055556 kelvin) to negative 400° Fahrenheit (33.15 kelvin).

In some examples, hydrogen and oxygen gases leaving the discharge turbines are combined in an exhaust stream. In alternate examples, gases remain separate and are bled from the discharge turbines. Gases that are bled from the turbines may be cooled (or sub-cooled). Cooled gases may condense into liquid. Liquid gases may be used in other devices and systems, for example as fuel in a propulsion system of an automobile.

Gases that are combined in an exhaust stream of the discharge turbines 12 and 14 may flow downstream to the gas turbine engine 16. One example of the gas turbine engine 16 is a combustion turbine engine. The combustion engine may burn oxygen and hydrogen as fuel, producing work and water vapor (i.e., steam). Steam may leave the gas turbine engine as an exhaust downstream to the lower level turbine.

The inert gas turbine 18 may be in thermal communication with the gas turbine engine 16 and the discharge turbines. In some examples the inert gas turbine is thermally coupled to the steam exhaust from the gas turbine engine. In other examples, the inert gas turbine is thermally coupled to the exhaust stream of the discharge turbines. The inert gas turbine may use the differences in temperatures between hot and cold parts within electricity generating station (e.g., between a first location in the electricity generating station and a second location in the electricity generating station) to generate useful energy (work). One such example is the inert gas turbine thermally coupled to two locations in the electricity generating station so that the inert gas turbine is in parallel with another turbine, such as the turbine engine (as shown). One example of the inert gas turbine is an Ericsson cycle engine. An alternate example of the inert gas turbine is a Sterling cycle engine. In this way, exhaust steam may be cooled, and efficiency of the electric generating station improved.

The lower level turbine collects the exhaust steam and condensed exhaust steam downstream of the gas turbine engine. The lower level turbine may feature conduits for condensing exhaust steam into liquid water. Liquid water may be collected. In one example, the collected liquid water may be used to run a hydroelectric turbine to generate work. In another example, water leaving the lower level turbine may be used for other systems and devices, such as to sustain agriculture or be used for municipal purposes. In alternate embodiments, water is outlet into the environment.

FIG. 2 is a schematic diagram of an alternate electricity generating station 202. The alternate electricity generating station is an example of a system that may be used to carry out a method of harnessing energy from a high pressure gas, the pressure created by a body of water under a landmass 206. The alternate electricity generating station is in fluid communication with an underground body of water 204, such as a well. The well may be a fresh water or salt water well. In other alternate examples, the electricity generating station is in fluid communication with a closed underground well system, isolated from outside sources of water.

The alternate electricity generating station may be another embodiment of the electricity generating station and may include the same components and device as the electricity generating station (as shown). The alternate electricity generating station may function in a manner similar to the electricity generating station. The electricity generating station may further include a re-feeding system, for returning water underground. In other alternate examples, the electricity generating station is in fluid communication with the closed underground well system described above. The closed underground well system may include pipes and one or more reservoirs 210 for storing and transporting water. In this way, water may be isolated from outside ground water, kept pure and stored.

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

1. A method for harnessing energy from pressures generated by bodies of water, the method comprising:
producing hydrogen and oxygen gas from water by electrolysis, the electrolysis preformed under high pressure; and
generating energy via a pressure difference between an atmospheric air pressure and the hydrogen and oxygen gas under high pressure.

2. The method of claim 1, further comprising flowing gas through a turbine, the gas flow spinning the turbine and generating electricity, the flow resulting from the pressure difference.

3. The method of claim 2, wherein the turbine spins from the flow of at least one of oxygen and hydrogen gas, the turbine at or above sea level.

4. The method of claim 2, further comprising:
combining hydrogen and oxygen gases; and
burning the gases to produce work and water vapor, the burning including combusting, and the water vapor being a steam exhaust.

5. The method of claim 4, further comprising:
receiving at least one of the steam exhaust and a condensed steam exhaust into a conduit included in a hydroelectric turbine, the conduit condensing the steam exhaust into liquid water, the turbine further collecting the liquid water; and
running the hydroelectric turbine to generate work with the collected liquid water.

6. The method of claim 4, where the turbine is run with an inert gas, the inert gas thermally coupled to the hydrogen and oxygen gases at a first location where the gases are not combusted and the inert gas thermally coupled at a second location, downstream of the first location where the gases are combusted as steam exhaust, a difference in temperatures of the pre-combustion gases and steam exhaust used to generate work.

7. The method of claim 1, further comprising recombining the hydrogen and oxygen gas to yield water and using the water for at least one of agricultural and municipal purposes.

8. The method of claim 1, further comprising bleeding one or more of the hydrogen and oxygen gases to be stored and used as fuel for an engine.

9. An electricity generating station comprising:
an electrolysis plant located underwater, the electrolysis plant producing hydrogen and oxygen gas from water under high pressure;
an oxygen discharge turbine coupled downstream coupled to the electrolysis plant downstream via piping; and
a hydrogen discharge turbine coupled downstream coupled downstream via piping to the electrolysis plant and the hydrogen discharge turbine in parallel with the oxygen discharge turbine.

10. The electricity generating station of claim 9, further comprising a gas turbine engine coupled downstream to the oxygen discharge turbine and hydrogen discharge turbine, the gas turbine engine combining hydrogen and oxygen gases and combusting the gases to produce work and steam exhaust.

11. The electricity generating station of claim 9, further comprising a condenser coupled to at least one of the oxygen discharge turbine and hydrogen discharge turbine, the condenser condensing at least one of the hydrogen and oxygen gas into a liquefied gas, the liquefied gas to be used as fuel in a propulsion system of an automobile.

12. The electricity generating station of claim 9, further comprising an inert gas turbine thermally coupled to at least one of the gas turbine engine and the discharge turbines, the inert gas turbine also coupled to at least two locations within the electricity generating station, and the inert gas turbine generating work via a difference in temperatures between the two locations.

13. The electricity generating station of claim 9, further comprising a hydroelectric lower level turbine, the turbine receiving the steam exhaust and condensed steam exhaust, the turbine including a conduit for condensing the steam exhaust into liquid water, the turbine further collecting the liquid water to run a hydroelectric turbine to generate work.

14. The electricity generating station of claim 9, where the body of water is an ocean.

15. The electricity generating station of claim 9, where the body of water is an underground fresh water source.

16. The electricity generating station of claim 15, where electricity generating station is in fluid communication with a closed underground well system, the electricity generating station further comprising a re-feeding system for returning water underground, the closed underground well system including pipes and one or more reservoirs for storing and transporting water.

17. A method of generating electricity in a generating station, the generating station comprising an electrolysis plant submerged in a body of water and a discharge turbine, the method comprising:
producing hydrogen and oxygen gas from water in the underwater electrolysis plant, the electrolysis preformed under high pressure;
transporting at least one of the hydrogen and oxygen gases to the discharge turbine coupled downstream to the electrolysis plant via piping; and
generating energy by flowing gas through the turbine, the gas flow spinning the turbine, the flow resulting from a pressure difference in the transported gas and an atmospheric air pressure at the discharge turbine.

18. The method of claim 17, where the generating station further comprises an inert gas turbine thermally coupled to the hydrogen and oxygen gases at a first location and a second location, the method further comprising flowing inert gas through the inert gas turbine generating work, the flow resulting from the a difference in temperatures between the first location and the second location.

19. The method of claim 17, where the generating station is in fluid communication with a closed underground well system, the method comprising re-feeding water to the closed underground well system via at least one of a pipe and a reservoir.

20. The method of claim 17, where the generating station further comprises a turbine engine, the method further comprising:
combining hydrogen and oxygen gases upstream of the turbine engine; and
burning oxygen and hydrogen as fuel, producing work and water vapor.
